(19) United States
(12) Patent Application Publication
(10) Pub. No.: US 2013/0304814 A1
(43) Pub. Date: Nov. 14, 2013

(54) INFORMATION PROCESSING DEVICE, INFORMATION PROCESSING METHOD AND NON-TRANSITORY STORAGE MEDIUM STORING INFORMATION PROCESSING PROGRAM

(71) Applicant: Akihisa Kurashima, Tokyo (JP)

(72) Inventor: Akihisa Kurashima, Tokyo (JP)

(73) Assignee: NEC CORPORATION, Minato-ku, Tokyo (JP)

(21) Appl. No.: 13/997,704

(22) PCT Filed: Dec. 22, 2011
(86) PCT No.: PCT/JP2011/007213

§ 371 Date: Jun. 25, 2013

(30) Foreign Application Priority Data
Dec. 28, 2010 (JP) 2010-292007

(51) Int. Cl. H04L 29/08

(52) U.S. Cl. CPC H04L 67/02
USPC 709/203

(57) ABSTRACT

Provided is an information processing device including: a determination unit that analyzes Web contents sent from a Web server to a. Web client and determines whether or not a communication link for starting communication to a specific party from the Web client is included in the Web contents; and a link addition unit that, when the communication link is included in the Web contents according to the results of the determination of the determination unit, adds to the Web contents a link to an additional information screen in which additional information for performing communication to the specific party from the Web client is described.

### TECHNICAL FIELD

The present invention relates to a technique that converts Web contents.

### BACKGROUND ART

In the above technical field, as disclosed in Patent Document 1, a technique is known that embeds a link for communication such as mailto:, tel:, or callto: in Web contents and cause a designated unit to select the communication.

### RELATED DOCUMENT

### Patent Document

[Patent Document 1] Japanese Unexamined Patent Publication No. 2007-128166

### DISCLOSURE OF THE INVENTION

However, in the above technique of the related art, communication cannot be selected using a method other than a designated method.

An object of the invention is to provide a technique for solving the above-described problem.

In order to accomplish the above object, there is provided an information processing device including: a determination unit that analyzes Web contents sent from a Web server to a Web client and determines whether or not a communication link for starting communication to a specific party from the Web client is included in the Web contents; and a link addition unit that, when the communication link is included in the Web contents according to the results of the determination of the determination unit, adds to the Web contents a link to an additional information screen in which additional information for performing communication to the specific party from the Web client is described.

In order to accomplish the above object, there is also provided an information processing method including: a determination step of analyzing Web contents sent from a Web server to a Web client in response to a request of the Web client, and determining whether or not a communication link for starting communication to a specific party from the Web client is included in the Web contents; and a link addition step of adding, when the communication link is included in the Web contents according to the results of the determination of the determination unit, a link to an additional information screen in which additional information for performing communication to the specific party from the Web client is described.

In order to accomplish the above object, there is also provided an information processing program causing a computer to execute an information processing method including: a determination step of analyzing Web contents sent from a Web server to a Web client in response to a request of the Web client, and determining whether or not a communication link for starting communication to a specific party from the Web client is included in the Web contents; and a link addition step of adding, when the communication link is included in the Web contents according to the results of the determination of the determination step, a link to an additional information screen in which additional information for performing communication to the specific party from the Web client is described.

According to the invention, communication can be selected using a method other than a designated method.

### BRIEF DESCRIPTION OF THE DRAWINGS

The above-described objects, other objects, features and advantages will be further apparent from the preferred embodiments described below, and the accompanying drawings as follows.

FIG. 1 is a block diagram illustrating a configuration of an information processing device according to a first embodiment of the invention.

FIG. 2 is a block diagram illustrating a configuration of an information processing system according to a second embodiment of the invention.

FIG. 3 is a block diagram illustrating a detailed configuration of the information processing system according to the second embodiment of the invention.

FIG. 4 is a flow chart illustrating a processing flow in a relay server according to the second embodiment of the invention.

FIG. 5 is a diagram illustrating a content conversion process in the relay server according to the second embodiment of the invention.

FIG. 6 is a diagram illustrating a content conversion process in the relay server according to the second embodiment of the invention.

FIG. 7 is a diagram illustrating a content conversion process in the relay server according to the second embodiment of the invention.

FIG. 8 is a diagram illustrating a content conversion process in a relay server according to a third embodiment of the invention.

FIG. 9 is a block diagram illustrating a detailed configuration of an information processing system according to a fourth embodiment of the invention.

FIG. 10 is a flow chart illustrating a processing flow in a relay server according to the fourth embodiment of the invention.

### DESCRIPTION OF EMBODIMENTS

Hereinafter, embodiments of the invention will be described in detail with reference to the accompanying drawings. However, components described in the following embodiments are merely illustrative of the invention, and the technical scope of the invention is not limited to only them.

### First Embodiment

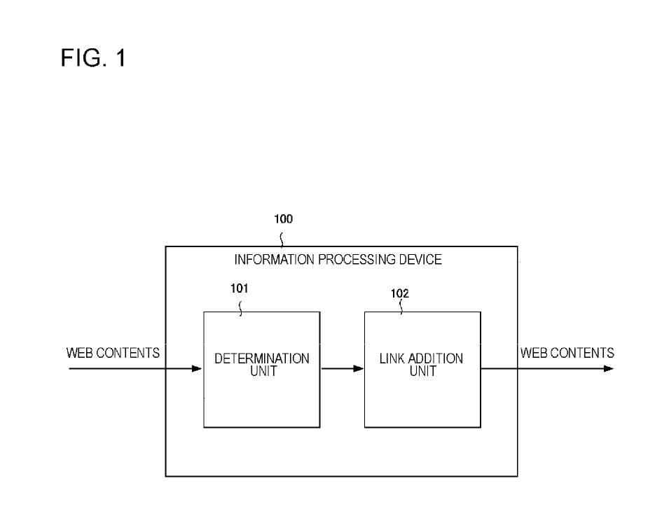

Hereinafter, an information processing device 100 according to a first embodiment of the invention will be described with reference to FIG. 1. The information processing device 100 is a device that deals with Web contents that are sent from a Web server to a Web client.

As shown in FIG. 1, the information processing device 100 includes a determination unit 101 and a link addition unit 102. The determination unit 101 analyzes Web contents that are sent from a Web server to a Web client, and determines whether or not a communication link for starting communication to a specific party from the Web client is included in the Web contents.

If the communication link is included in the Web contents according to the results of the determination of the determination unit 101, the link addition unit 102 adds to the Web contents a link to an additional information screen. Here, the additional information screen is a screen in which additional information for performing communication to the specific party from the Web client is described.

As such, a user can select the communication using a method other than a designated method by adding a link to the additional information screen.

### Second Embodiment

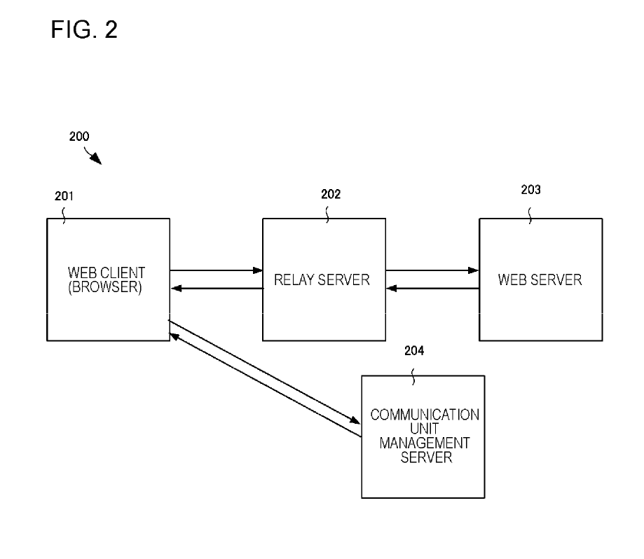

Hereinafter, an information processing system 200 according to a second embodiment of the invention will be described with reference to FIG. 2. The information processing system 200 includes a Web client 201 and a Web server 203, and further includes a relay server 202 between the Web client 201 and the Web server 203. The Web client 201 is a device including a Web browser. The relay server 202 is a device that performs a predetermined process on the Web contents sent from the Web server 203 to the Web client 201. In addition, the information processing system 200 further includes a communication unit management server 204 that can access from the Web client 201 through a network.

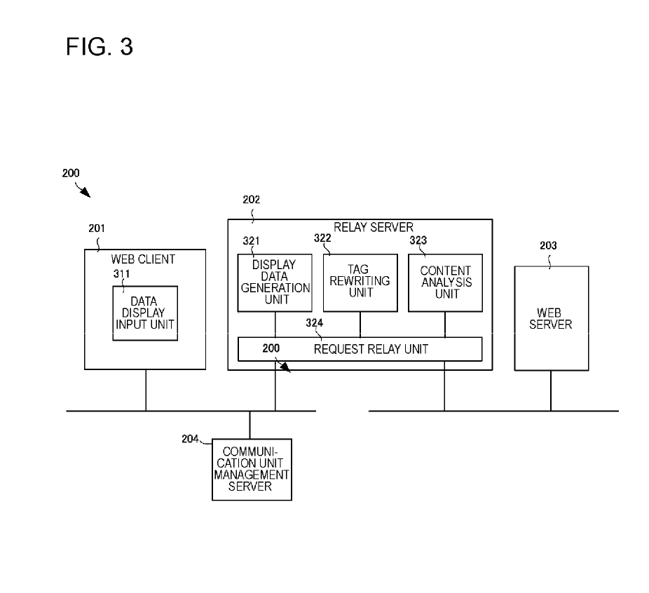

FIG. 3 is a diagram illustrating a detailed internal configuration of each component of the information processing system 200. As shown in FIG. 3, the Web client 201 includes a data display input unit 311 such as a Web browser. In addition, the relay server 202 includes a display data generation unit 321 that generates display data to be displayed on the data display input unit 311 of the Web client. The relay server 202 includes a content analysis unit 323 that analyzes the Web contents, and a tag rewriting unit 322 that rewrites a tag in the Web contents. Further, the relay server 202 includes a request relay unit 324 that relays a request between the Web client 201 and the Web server 203.

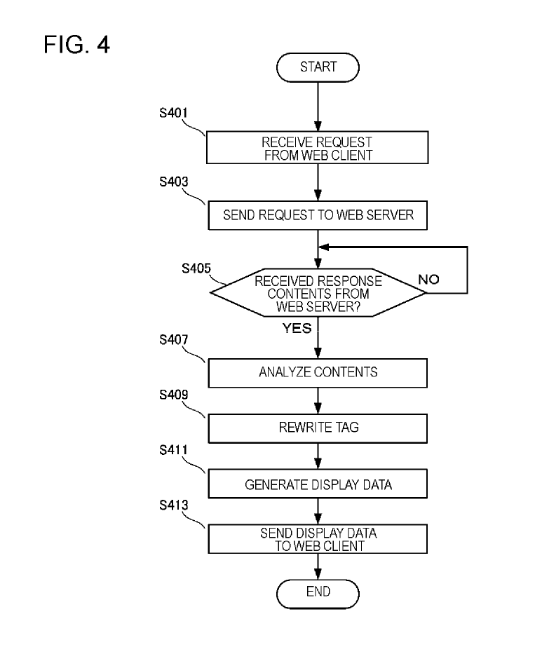

FIG. 4 is a flow chart illustrating a processing flow in the relay server 202.

First, in step S401, a request that has designated an URL is received from the data display input unit 311 of the Web client 201. Next, in step S403, the request relay unit 324 sends the received request to the Web server 203 that is designated by the URL.

Next, in step S405, the relay server 202 stands by until the relay server 202 receives the Web contents as a response to the request from the Web server 203. If the relay server 202 receives the Web contents from the Web server 203, the process proceeds to step S407.

In step S407, the request relay unit 324 passes the received Web contents to the content analysis unit 323, and the content analysis unit 323 analyzes the Web contents, and thus the content analysis unit 323 passes the analyzed Web contents as internal processing data to the tag rewriting unit 322.

In step S409, the tag rewriting unit 322 searches for an <a> tag to which a href attribute is given. When the <a> tag is found, a value of the href attribute is confirmed, and it is determined whether or not mailto:, tel:, callto:, sip:, and the like, an e-mail address, a phone number, and the like are an URL (communication link) that is related to a person. In other words, it is determined whether or not the communication link for starting communication to a specific party from the Web client is included in the Web contents. Specifically, it is determined whether or not the URL is a link to any one of an extension number, an external number, an e-mail address, and an identifier (SIP-URI) of a communication resource of a session establishment protocol of the specific party. When the communication link included in the Web contents is detected, an <a> tag with a link (href attribute value) for a communication unit management server (additional information screen) is added after the <a> tag. Specifically, for example, when an <a> tag such as “<a href=“mailto:xxx@yy.zzz”> . . . </a>” is found in the contents, an <a> tag such as “<a href=“http://com.mgmt.server.name/?href=mailto%3axxx@yy.zzz”><img src=“http://com.mgmt.server.name/link.png”></a>” is added after the <a> tag. In this regard, the original href attribute value is given to a parameter of an URL of the communication unit management server 204. The given href attribute value may be changed by a certain rule when being given as a parameter. For example, “mailto:xxx@yy.zzz” may be url-encoded to “mailto %3axxx@yy.zzz”. The communication unit management server 204 previously includes (or can generate), as contents causing an additional information screen to be displayed, contents including additional information for performing communication with respect to the specific party using a plurality of methods.

In step S411, the display data generation unit 321 converts the rewritten internal processing data into a data format that can be displayed on the data display input unit 311 of the Web client 201, and passes the converted rewritten internal processing data to the request relay unit 324.

In step S413, the request relay unit 324 sends the passed display data as a response to the request from the Web client 201. The data display input unit 311 of the Web client 201 displays the received response data on a screen. Here, if a link to the rewritten (or added) communication unit management server 204 is selected, the Web client 201 sends a request to the communication unit management server 204 and displays a response thereto on the screen.

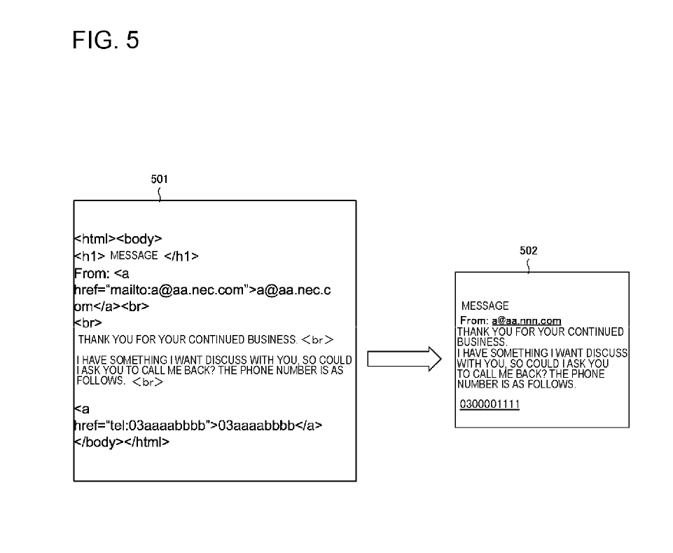

FIG. 5 is a diagram illustrating examples of Web contents 501 and a display screen 502. The Web contents 501 are contents that are prepared (or generated) in the Web server 203. When the Web contents 501 are output directly by the data display input unit 311 of the Web client 201 without performing any process, the display screen 502 is output.

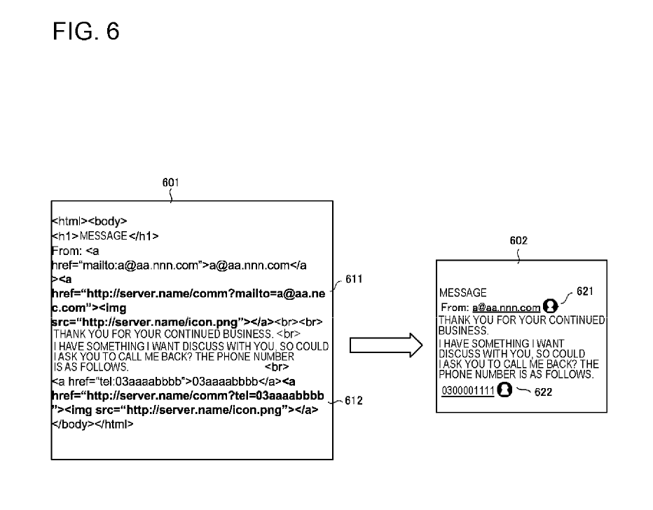

The relay server 202 performs a process on the Web contents 501, and thus Web contents 601 as shown in FIG. 6 are generated. In other words, bold parts 611 and 612 are added. For this reason, the output in the data display input unit 311 of the Web client 201 is as shown on a display screen 602. Specifically, icons 621 and 622 are added.

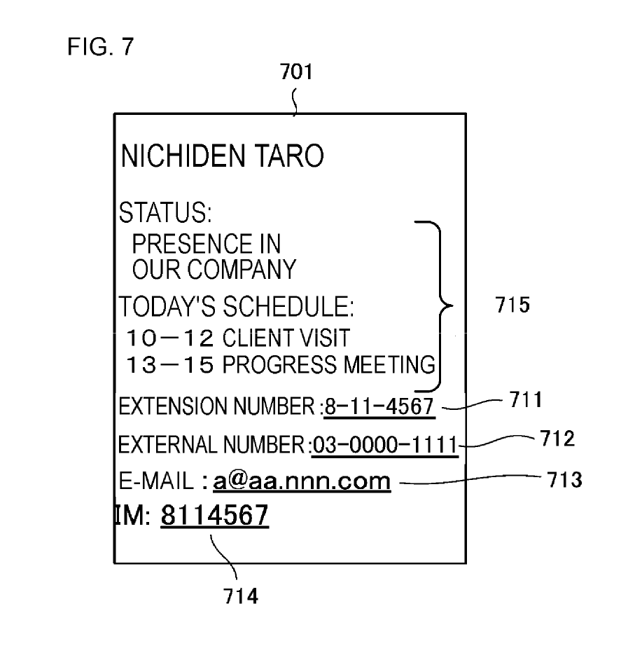

When the icons 621 and 622 on the display screen 602 of FIG. 6 are clicked, a request for contents to the communication unit management server 204 is sent from the Web client 201. On the other hand, when the data display input unit 311 of the Web client 201 outputs the Web contents sent back from the communication unit management server 204, a display screen 701 is output as shown in FIG. 7.

The display screen 701 includes, as additional information, an extension number 711, an external number 712, an e-mail address 713, and an SIP-URI (identifier of communication resource of session establishment protocol) 714 of the specific party. The display screen 701 further includes, as additional information, the location and a schedule 715 of the specific party.

By configuring as described above, according to the embodiment, a user can select communication using a method other than a designated method.

### Third Embodiment

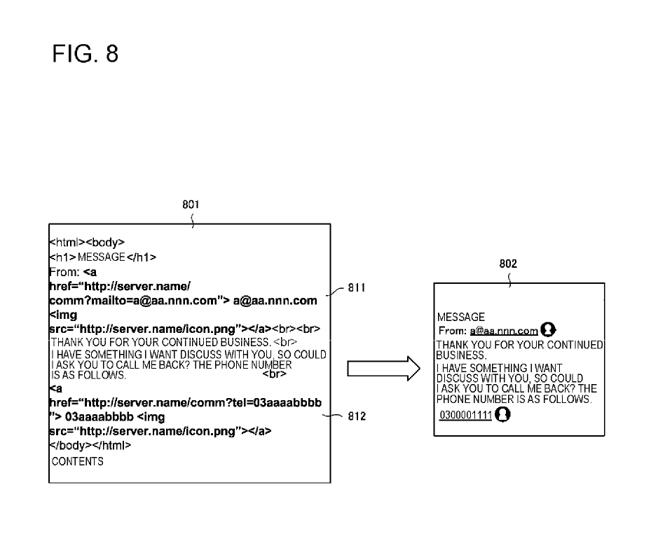

Hereinafter, a third embodiment of the invention will be described with reference to FIG. 8. In the second embodiment, although a rewriting method that adds a new <a> tag after an <a> tag is employed in the Web contents, a process of rewriting href of an <a> tag is performed in the embodiment.

In other words, the Web contents 501 shown in FIG. 5 are converted into Web contents 801 of FIG. 8 by rewriting. That is, bold parts 811 and 812 are generated, and some of the original contents are overwritten. As a result, a href attribute value changes. A display screen 802 that is the same as that of the second embodiment is also generated through the conversion method, and thus the same effect can be achieved.

### Fourth Embodiment

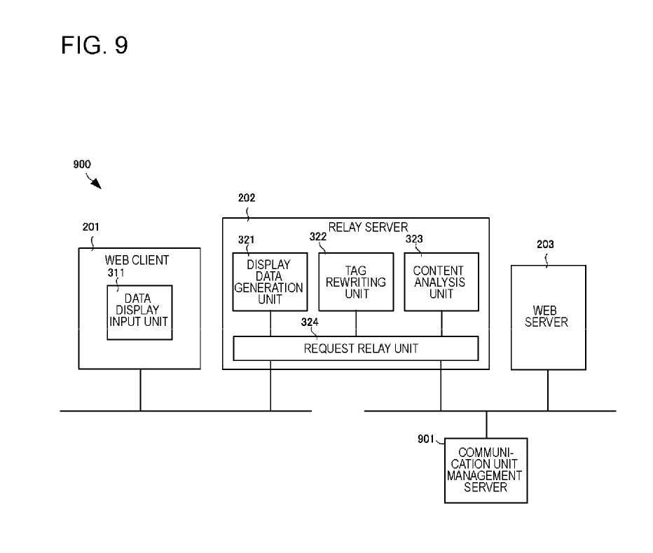

Hereinafter, an information processing system 900 according to a fourth embodiment of the invention will be described with reference to FIG. 9. In the second embodiment, as shown in FIG. 3, the Web client 201 can access the communication unit management server 204 without the aid of the relay server 202. On the other hand, in the embodiment, a communication unit management server 901 is disposed on the Web server 203 side, and the Web client 201 also accesses the communication unit management server 901 via the relay server 202.

In this configuration, the relay server 202 is located at a fire wall, and the Web client 201 and the communication unit management server 901 are located inside the fire wall. At this time, the relay server 202 certifies the access from the Web client 201 on the Internet and performs the concealment (encryption) of communication thereof, and thus the security of a system can be ensured. However, in such a case, since contents of the communication unit management server 901 also pass the relay server 202, this becomes a target of rewriting the Web contents according to the invention in that state.

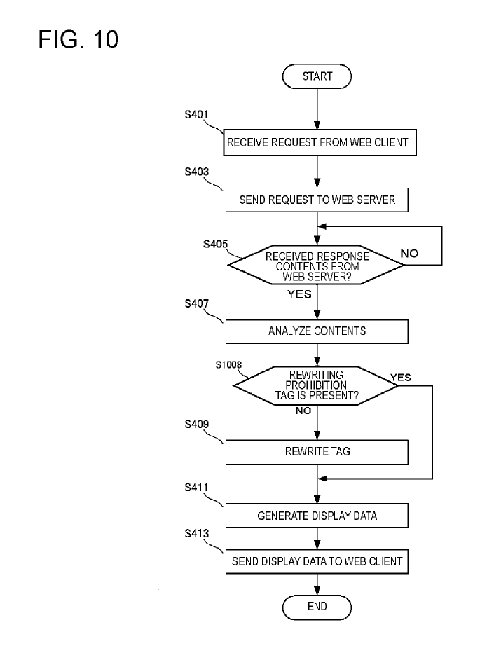

Hereinafter, a method of avoiding this will be described with reference to FIG. 10. In the above-described embodiment, when the communication link is included in the Web contents, the link to the additional information screen is necessarily added. On the other hand, in the embodiment, when information indicating that the link to the additional information screen should not be added is included in the Web contents, the link is not added. Since other components and processes are the same as those of the second embodiment, like reference numerals denote like components and processes, and the description thereof will not be repeated.

FIG. 10 is a flow chart illustrating a processing flow in the relay server 202 according to the embodiment of the invention.

First, in step S401, a request that has designated an URL is received from the data display input unit 311 of the Web client 201. Next, in step S403, the request relay unit 324 sends the received request to the Web server 203 that is designated by the URL.

Next, in step S405, the relay server 202 stands by until the relay server 202 receives Web contents as a response to the request from the Web server 203. If the relay server 202 receives the Web contents from the Web server 203, the process proceeds to step S407.

In step S407, the request relay unit 324 passes the received Web contents to the content analysis unit 323, and the content analysis unit 323 analyzes the Web contents, and thus the content analysis unit 323 passes the analyzed Web contents as internal processing data to the tag rewriting unit 322.

Next, in step S1008, it is determined whether or not any information (for example, rewriting prohibition tag) indicating that the Web contents should not be rewritten is included in the Web contents. The rewriting prohibition tag is, for example, a <meta> tag. As such, when an attribute is designated indicating that the tag should not be rewritten into an extended attribute of the <a> tag or another tag including the <a> tag, the process proceeds to step S411 without performing rewriting. On the other hand, when the information indicating that the Web contents should not be rewritten is not included in the Web contents, the process proceeds to step S409.

In step S409, the tag rewriting unit 322 searches for the <a> tag to which the href attribute is given. When the <a> tag is found, a value of the href attribute is confirmed, and it is determined whether or not mailto:, tel:, callto:, sip:, and the like, an e-mail address, a phone number, and the like are an URL (communication link) that is related to a human. In other words, it is determined whether or not the communication link for starting communication to a specific party from the Web client is included in the Web contents. Specifically, it is determined whether or not the URL is a link to any one of an extension number, an external number, an e-mail address, and an identifier (SIP-URI) of a communication resource of a session establishment protocol of the specific party. When the communication link included in the Web contents is detected, a link (href attribute value) for a communication unit management server (additional information screen) is added after the <a> tag. In this regard, the href attribute value is given to a parameter of an URL of the communication unit management server 901. The communication unit management server 901 previously includes (or can generate), as contents causing an additional information screen to be displayed, contents including additional information for performing communication with respect to the specific party using a plurality of methods.

In step S411, the display data generation unit 321 converts the rewritten internal processing data into a data format that can be displayed on the data display input unit 311 of the Web client 201, and passes the converted rewritten internal processing data to the request relay unit 324.

In step S413, the request relay unit 324 sends the passed display data as a response to the request from the Web client 201. The data display input unit 311 of the Web client 201 displays the received response data on a screen. Here, if a link to the rewritten (or added) communication unit management server 901 is selected, the Web client 201 sends a request to the communication unit management server 901 and displays a response thereto on the screen. At this time, the communication unit management server 901 includes any information (for example, rewriting prohibition tag) indicating that the Web contents should not be rewritten in the contents.

As described above, the communication unit management server includes information that prevents rewriting so that the contents are not rewritten at the time of response, and thus unnecessary rewriting performed by a tag rewriting unit can be prevented.

### Other Embodiments

Although the embodiments of the invention have been described, systems or devices in which individual characteristics included in the embodiments are combined in various ways are included in the scope of the invention.

In addition, the invention may be applied to a system constituted by a plurality of devices, or may be applied to a single device. Further, the invention can also be applied to a case where an information processing program realizing functions of the embodiments is provided to the system or the device directly or remotely. Therefore, in order to realize the functions of the invention using a computer, a program installed in the computer, a medium storing the program, and a WWW (World Wide Web) server causing the program to be downloaded are all included in the scope of the invention.

The application is based on Japanese Patent Application No. 2010-292007 filed on Dec. 28, 2010, the content of which is incorporated herein by reference.

What is claimed is:

1. An information processing device comprising:
a determination unit that analyzes Web contents sent from a Web server to a Web client and determines whether or not a communication link for starting communication to a specific party from the Web client is included in the Web contents; and
a link addition unit that, when the communication link is included in the Web contents according to the results of the determination of the determination unit, adds to the Web contents a link to an additional information screen in which additional information for performing communication to the specific party from the Web client is described.

2. The information processing device according to claim 1, wherein the link addition unit adds the link to the additional information screen to the Web contents by adding a new tag.

3. The information processing device according to claim 1, wherein the link addition unit adds the link to the additional information screen to the Web contents by changing a link destination of an existing tag.

4. The information processing device according to claim 1, wherein the communication link is a link to any one of an extension number, an external number, an e-mail address, and an identifier (SIP-URI) of a communication resource of a session establishment protocol of the specific party.

5. The information processing device according to claim 1, wherein the additional information screen includes additional information for performing communication with respect to the specific party using a plurality of methods.

6. The information processing device according to claim 5, wherein the additional information includes at least one of an extension number, an external number, an e-mail address, and an identifier (SIP-URI) of a communication resource of a session establishment protocol of the specific party.

7. The information processing device according to claim 5, wherein the additional information includes at least one of the location and a schedule of the specific party.

8. The information processing device according to claim 1, wherein the link addition unit, even if the communication link is included in the Web contents according to the results of the determination of the determination unit, does not add the link when information indicating that a link to the additional information screen should not be added is included in the Web contents.

9. An information processing method comprising:
a determination step of analyzing Web contents sent from a Web server to a Web client in response to a request of the Web client, and determining whether or not a communication link for starting communication to a specific party from the Web client is included in the Web contents; and
a link addition step of adding, when the communication link is included in the Web contents according to the results of the determination of the determination unit, a link to an additional information screen in which additional information for performing communication to the specific party from the Web client is described.

10. A non-transitory storage medium storing an information processing program causing a computer to execute an information processing method comprising:
a determination step of analyzing Web contents sent from a Web server to a Web client in response to a request of the Web client, and determining whether or not a communication link for starting communication to a specific party from the Web client is included in the Web contents; and
a link addition step of adding, when the communication link is included in the Web contents according to the results of the determination of the determination step, a link to an additional information screen in which additional information for performing communication to the specific party from the Web client is described.
